(19) United States
(12) Patent Application Publication
(10) Pub. No.: US 2025/0313426 A1
(43) Pub. Date: Oct. 9, 2025

(54) SHEET DISCHARGING APPARATUS AND IMAGE FORMING APPARATUS

(71) Applicant: CANON KABUSHIKI KAISHA, Tokyo (JP)

(72) Inventors: YUYA HAMAJI, Chiba (JP); YUKINOJO TODA, Saitama (JP)

(21) Appl. No.: 19/085,382

(22) Filed: Mar. 20, 2025

(30) Foreign Application Priority Data
Apr. 5, 2024 (JP) 2024-061631

(51) Int. Cl. B65H 37/00; B65H 29/12; G03G 15/00

(52) U.S. Cl. CPC B65H 37/00; B65H 29/12; G03G 15/6552; B65H 2301/44318; B65H 2301/5133; B65H 2401/15; B65H 2801/06

(57) ABSTRACT

A sheet discharging apparatus includes a sheet discharge unit configured to discharge a sheet in a sheet discharge direction, a sheet supporting unit configured to support the sheet, a first charge eliminating unit arranged downstream of the sheet discharge unit in the sheet discharge direction and configured to eliminate electric charge from a surface of the sheet, a second charge eliminating unit arranged downstream of the first charge eliminating unit in the sheet discharge direction and configured to eliminate electric charge from a surface of the sheet. The first charge eliminating unit includes a plurality of first charge eliminating portions that are aligned with a first pitch in an intersecting direction intersecting the sheet discharge direction. The second charge eliminating unit includes a plurality of second charge eliminating portions that are aligned with a second pitch, that differs from the first pitch, in the intersecting direction.

### BACKGROUND OF THE INVENTION

### Field of the Invention

The present invention relates to a sheet discharging apparatus for discharging sheets, and an image forming apparatus equipped with the same.

### Description of the Related Art

Hitherto, an image forming apparatus that eliminates charge by a first charge eliminating portion and a second charge eliminating portion from sheets on which a toner image has been formed and that has been discharged by a sheet discharge roller pair has been proposed (refer for example to Japanese Patent Application Laid-Open Publication No. 2017-030917). In a conveyance direction, the first charge eliminating portion is arranged downstream of and above the sheet discharge roller pair, and the second charge eliminating portion is arranged upstream of and below the sheet discharge roller pair. The first charge eliminating portion and the second charge eliminating portion eliminate charge from an upper surface and a lower surface of the sheet. The first charge eliminating portion and the second charge eliminating portion each include a plurality of charge eliminating needles that are aligned in a sheet width direction orthogonal to the conveyance direction of the sheet.

Along with the increase in speed and enhancement in function of the image forming apparatus, the amount of static electricity delivered via discharged sheets to a sheet discharge tray per unit time has increased. Therefore, according to the first charge eliminating portion and the second charge eliminating portion described in the above-mentioned Japanese Patent Application Laid-Open Publication No. 2017-030917, it may not be possible to sufficiently remove the electric charge charged on the sheets, such that sheets may be attracted to or repelled from each other, which may cause problems from the viewpoint of stackability of sheets on the sheet discharge tray.

### SUMMARY OF THE INVENTION

According to a first aspect of the present invention, a sheet discharging apparatus includes a sheet discharge unit configured to discharge a sheet in a sheet discharge direction, a sheet supporting unit configured to support the sheet discharged by the sheet discharge unit, a first charge eliminating unit arranged downstream of the sheet discharge unit in the sheet discharge direction and configured to eliminate electric charge from a surface of the sheet, a second charge eliminating unit arranged downstream of the first charge eliminating unit in the sheet discharge direction and configured to eliminate electric charge from a surface of the sheet. The first charge eliminating unit includes a plurality of first charge eliminating portions that are aligned with a first pitch in an intersecting direction intersecting the sheet discharge direction. The second charge eliminating unit includes a plurality of second charge eliminating portions that are aligned with a second pitch, that differs from the first pitch, in the intersecting direction.

According to a second aspect of the present invention, a sheet discharging apparatus includes a sheet discharge unit configured to discharge a sheet in a sheet discharge direction, a sheet supporting unit configured to support the sheet discharged by the sheet discharge unit, a first charge eliminating unit arranged downstream of the sheet discharge unit in the sheet discharge direction and configured to eliminate electric charge from a surface of the sheet, and a second charge eliminating unit arranged downstream of the first charge eliminating unit in the sheet discharge direction and configured to eliminate electric charge from a surface of the sheet. The first charge eliminating unit includes a plurality of upstream charge eliminating portions aligned in an intersecting direction intersecting the sheet discharge direction, the plurality of upstream charge eliminating portions including a first upstream charge eliminating portion and a second upstream charge eliminating portion that are arranged adjacent to each other in the intersecting direction. The second charge eliminating unit includes a plurality of downstream charge eliminating portions aligned in the intersecting direction, the plurality of downstream charge eliminating portions including a first downstream charge eliminating portion and a second downstream charge eliminating portion that are arranged adjacent to each other in the intersecting direction. A first distance between the first upstream charge eliminating portion and the second upstream charge eliminating portion differs from a second distance between the first downstream charge eliminating portion and the second downstream charge eliminating portion in the intersecting direction.

Further features of the present invention will become apparent from the following description of exemplary embodiments with reference to the attached drawings.

### BRIEF DESCRIPTION OF THE DRAWINGS

FIG. 1 is an entire schematic diagram illustrating a cross-sectional configuration of an image forming apparatus according to a first embodiment.

FIG. 2A is a perspective view of a sheet discharging apparatus.

FIG. 2B is a perspective view of a sheet discharging apparatus body.

FIG. 2C is a perspective view of an extension unit.

FIG. 3A is a front view of a first charge eliminating unit.

FIG. 3B is a front view of a second charge eliminating unit.

FIG. 4 is a cross-sectional view of a sheet discharging apparatus.

FIG. 5A is a front view of a first charge eliminating unit according to a second embodiment.

FIG. 5B is a front view of a second charge eliminating unit.

### DESCRIPTION OF THE EMBODIMENTS

### First Embodiment

### Entire Configuration

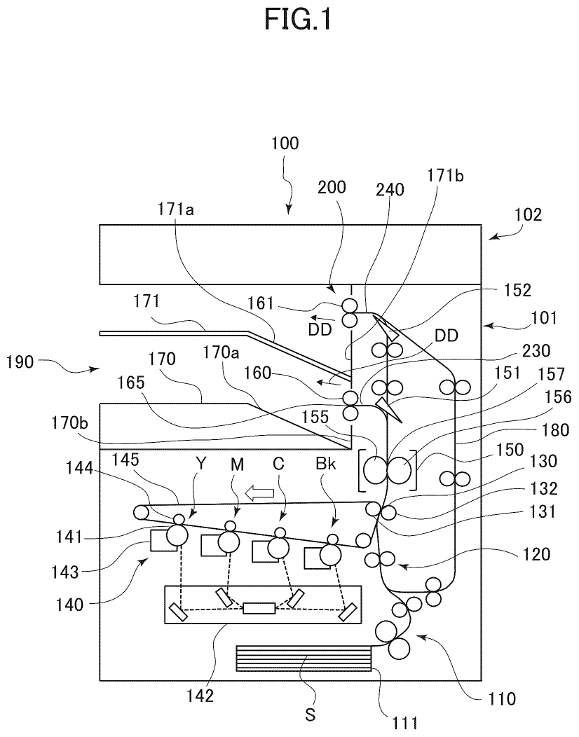

A first embodiment of the present technique will be described. FIG. 1 is an entire schematic diagram illustrating a cross-sectional configuration of an image forming apparatus 100 according to the first embodiment. The image forming apparatus 100 includes an image forming unit 140 for forming images on sheets S serving as recording material, a sheet feed unit 110, a fixing unit 150, a sheet discharging apparatus 200, and an image reading apparatus 102. Further, the image forming apparatus 100 includes an apparatus body 101 that serves as a casing for accommodating the image forming unit 140.

The image forming apparatus may include a printer, a copying machine, a facsimile, and a multifunction device, and refers to an apparatus that forms images on sheets serving as recording medium based on image information entered from an external PC or image information read from a document. Further, in addition to a main body having an image forming function, the image forming apparatus may have an auxiliary device such as an option feeder, an image reading apparatus, and a sheet processing apparatus connected thereto, and in such case, the entire system including the connected auxiliary device is recognized as one type of image forming apparatus.

The image forming unit 140 is an intermediate transfer tandem-type electrophotographic unit in which image forming stations Y, M, C, and Bk forming toner images of four colors are arranged along an intermediate transfer belt 145.

The sheet S is accommodated in a cassette 111 disposed on a lower portion of the apparatus body 101, and fed one by one by the sheet feed unit 110. The sheet feed unit 110 includes, for example, a feed roller for feeding the sheets S, and a separation roller disposed in contact with the feed roller and that applies frictional force to the sheet S to separate the sheet S fed from the feed roller from other sheets S. Various types of sheets of different sizes and materials may be used as the sheet S serving as a recording material, including paper such as normal paper and thick paper, plastic films, cloths, sheet materials such as coated paper having surface treatments applied thereto, and sheet materials having special shapes such as envelopes and index paper.

The sheet S fed from the sheet feed unit 110 is subjected to skew correction by a skew correction apparatus 120, and conveyed toward a transfer nip 130 at a timing synchronized with a toner image formation process by the image forming unit 140. The transfer nip 130 serving as a transfer portion is a nip portion that is formed between a secondary transfer inner roller 131 and a secondary transfer outer roller 132 opposing each other interposing the intermediate transfer belt 145, by which the sheet is nipped and conveyed.

In parallel with the conveyance process of the sheet S to the transfer nip 130 described above, the image forming unit 140 executes the toner image forming process. Each of the image forming stations Y, M, C, and Bk of the image forming unit 140 includes a photosensitive drum 141 servings a drum-shaped image bearing member, i.e., electrophotographic photosensitive member, a charge portion such as a charge roller, and a developing unit 143 serving as a developing portion. Further, the image forming unit 140 includes an exposing unit 142 arranged below the four photosensitive drums 141. In the toner image formation process, the charge portion charges the surface of each photosensitive drum 141 uniformly, and the exposing unit 142 exposes the photosensitive drum 141 based on signals of image information of the image that is to be formed, by which an electrostatic latent image is formed on the photosensitive drum 141. The electrostatic latent image is developed by toner supplied from the developing unit 143 and forms a single color toner image. Thereby, toner image of four colors, which are yellow, magenta, cyan, and black, are formed on the surface of each of the four photosensitive drums 141.

The intermediate transfer belt 145 is driven to rotate in a counterclockwise direction in FIG. 1. The toner images borne on the four photosensitive drums 141 are sequentially primarily transferred to the intermediate transfer belt 145 by primary transfer rollers 144 such that they are superposed. As a result, a full-color toner image is finally formed on the intermediate transfer belt 145, which is borne on the intermediate transfer belt 145 and conveyed to the transfer nip 130. The toner image is secondarily transferred from the intermediate transfer belt 145 to the sheet S by a pressing force and an electrostatic bias applied at the transfer nip 130.

The sheet S having passed through the transfer nip 130 is conveyed to the fixing unit 150. The fixing unit 150 includes a fixing roller 155 having a heater disposed therein and a pressure roller 156 that comes into contact by a predetermined pressing force with the fixing roller 155. The fixing roller 155 is driven by a driving source such as a motor not shown, and the pressure roller 156 is driven to rotate following the fixing roller 155. The fixing unit 150 applies pressure and heat to the toner image on the sheet S while nipping and conveying the sheet S by a fixing nip 157 serving as a fixing portion formed by the fixing roller 155 and the pressure roller 156. Toner is melted thereby, and toner is fixed after passing through the fixing nip, such that a fixed image on the sheet S is obtained.

The sheet S having passed through the fixing unit 150 is guided by a first guiding member 151 to either a first sheet discharge passage 230 leading to a first sheet discharge roller pair 160 or a second sheet discharge passage 240 leading to a second sheet discharge roller pair 161. When forming images on both surfaces of the sheet S, the sheet S having an image formed on a first surface is guided by the first guiding member 151 toward the second sheet discharge roller pair 161 and conveyed to the exterior of the apparatus by the second sheet discharge roller pair 161. When the trailing edge of the sheet S in the conveyance direction passes through a second guiding member 152, the second sheet discharge roller pair 161 reverses the conveyance direction of the sheet S and sends the sheet S into a duplex conveyance path 180. The portion of the sheet S that protrudes to the exterior of the apparatus body 101 during a reversing operation by the second sheet discharge roller pair 161 is supported by a second sheet discharge tray 171. The sheet S having reached the skew correction apparatus 120 again via the duplex conveyance path 180 is subjected to skew correction and timing correction, and thereafter passed through the transfer nip 130 and the fixing unit 150, by which an image is formed on a second surface.

The sheet discharging apparatus 200 for discharging the sheet S to the exterior, that is, to the outer side of the apparatus body 101, is disposed downstream in a sheet conveyance direction of the fixing unit 150. The sheet discharging apparatus 200 includes the first sheet discharge roller pair 160, the second sheet discharge roller pair 161, a first sheet discharge tray 170, and the second sheet discharge tray 171.

When discharging the sheet S, the sheet S sent out from the fixing unit 150 is guided by the first guiding member 151 to the first sheet discharge roller pair 160 and discharged by the first sheet discharge roller pair 160 to the exterior of the apparatus body 101. The first sheet discharge tray 170 is disposed above the apparatus body 101, and the sheet S discharged by the first sheet discharge roller pair 160 is stacked, or supported, on the first sheet discharge tray 170. The upper surfaces of the first sheet discharge tray 170 and the second sheet discharge tray 171 include inclined surfaces 170a and 171a that are inclined upward toward a downstream side in a sheet discharge direction DD. The sheet S supported on the first sheet discharge tray 170 or the second sheet discharge tray 171 is slid by its own weight to the upstream side in the sheet discharge direction DD along an inclined surface 170a or 171a of the first sheet discharge tray 170 or the second sheet discharge tray 171. Alignment surfaces 170b and 171b that extend in an up-down direction, i.e., gravity direction, are disposed on the upstream side of the first sheet discharge tray 170 and the second sheet discharge tray 171 in the sheet discharge direction DD. The sheet S discharged to the exterior of the apparatus is slid along the inclined surface 170a or 171a of the first sheet discharge tray 170 or the second sheet discharge tray 171. Then, by having the trailing edge of the sheet S abut against the alignment surface 170b or 171b, the position of the sheet S supported on the first sheet discharge tray 170 or the second sheet discharge tray 171 is aligned.

The image forming apparatus 100 is equipped with the image reading apparatus 102 disposed on the upper portion of the apparatus body 101. The image reading apparatus 102 includes a platen glass on which the document is placed, and an image sensor for reading the image on the document via the platen glass. Further, the image reading apparatus 102 is equipped with an auto document feeder for feeding the documents set on a document tray sheet by sheet and causing the image sensor to read an image from the document. The image forming apparatus 100 according to the present embodiment adopts a so-called in-body sheet discharge type configuration in which an in-body sheet discharge space 190 of the sheet S is provided between the image forming unit 140 and the image reading apparatus 102 in the up-down direction. The in-body sheet discharge type configuration is advantageous in that an occupation area of the image forming apparatus 100 viewed from above may be downsized compared to a configuration in which the discharge space for sheets is arranged on the side of the apparatus body 101 by providing the first sheet discharge tray 170 on a side portion of the apparatus body 101.

The image forming unit 140 described above is one example of an image forming unit, and for example, the present technique may also be applied to a direct transfer-type electrophotographic unit in which the toner image formed on the photosensitive member is transferred to the sheet without interposing an intermediate transfer body.

### Sheet Discharging Apparatus

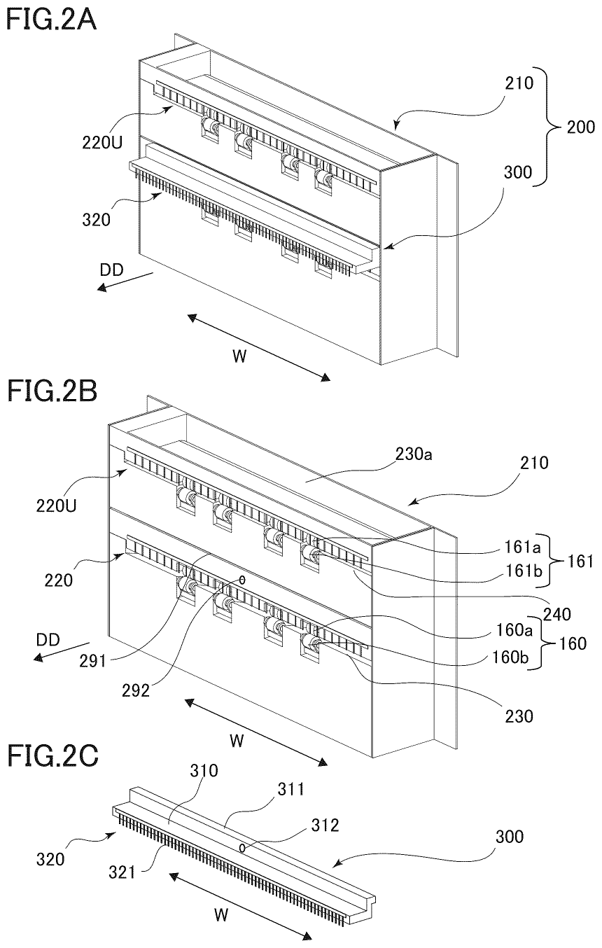

For example, the sheet discharging apparatus 200 will be described with reference to FIGS. 2A to 2C. FIG. 2A is a perspective view illustrating the sheet discharging apparatus 200. FIG. 2B is a perspective view illustrating a sheet discharging apparatus body 210. FIG. 2C is a perspective view illustrating an extension unit 300.

As illustrated in FIG. 2A, the sheet discharging apparatus 200 includes the sheet discharging apparatus body 210 and the extension unit 300. As illustrated in FIG. 2B, the sheet discharging apparatus body 210 includes a sheet discharge frame 210a, the first sheet discharge roller pair 160 serving as a sheet discharge unit, and the second sheet discharge roller pair 161 disposed above the first sheet discharge roller pair 160. The first sheet discharge roller pair 160 and the second sheet discharge roller pair 161 discharge the sheet S in the sheet discharge direction DD.

Further, the sheet discharging apparatus body 210 includes a first charge eliminating unit 220 arranged downstream of the first sheet discharge roller pair 160 in the sheet discharge direction DD, and an upper charge eliminating unit 220U arranged downstream of the second sheet discharge roller pair 161 in the sheet discharge direction DD. The upper charge eliminating unit 220U includes a similar configuration as the first charge eliminating unit 220 described below, and removes electric charge from the surface of the sheet S discharged by the second sheet discharge roller pair 161.

According to the present embodiment, there are four first sheet discharge roller pairs 160 and four second sheet discharge roller pairs 161 each aligned in a width direction W intersecting the sheet discharge direction DD. However, the number of the first sheet discharge roller pair 160 and the second sheet discharge roller pair 161 is not limited to four, and they may be one to three, or even more than four. In the present embodiment, the width direction W serving as an intersecting direction is a direction orthogonal to the sheet discharge direction DD, but it may be any direction intersecting the sheet discharge direction DD.

The first sheet discharge roller pair 160 includes a drive roller 160a serving as a first roller, and a driven roller 160b serving as a second roller that is driven to rotate following the drive roller 160a. The driven roller 160b forms a nip portion 165 that nips and conveys the sheet S together with the drive roller 160a. Similarly, the second sheet discharge roller pair 161 includes a drive roller 161a, and a driven roller 161b that is driven to rotate following the drive roller 161a.

The sheet discharge frame 210a includes a slit 291 that extends in the width direction W, and a hole portion 292 arranged below the slit 291. The hole portion 292 is disposed approximately at a center of the sheet discharge frame 210a in the width direction W.

The extension unit 300 includes an extension frame 310 and a second charge eliminating unit 320, as illustrated in FIG. 2C. The extension frame 310 includes an engagement portion 311 that comes into engagement with the sheet discharge frame 210a of the sheet discharging apparatus body 210, and a hole portion 312. The hole portion 312 is positioned with the hole portion 292 of the sheet discharge frame 210a in a state where the engagement portion 311 is engaged with the sheet discharge frame 210a. By engaging the hole portions 292 and 312 with each other by a fastening member such as a screw, the extension unit 300 is fixed to the sheet discharging apparatus body 210. The extension unit 300 is configured removably with respect to the sheet discharging apparatus body 210, and the extension unit 300 may be attached or detached in accordance with the medium conveyed in the image forming apparatus 100.

In a state where the sheet S is discharged from the first sheet discharge passage 230, electric charge on the surface of the sheet S discharged to the exterior of the apparatus body 101 (refer to FIG. 1) by the first sheet discharge roller pair 160 may be eliminated by the first charge eliminating unit 220 and the second charge eliminating unit 320. The description “removal of electric charge” according to the present embodiment may also be referred to as “destatisizing”, and refers to reducing the amount of electric charge on the surface of the sheet S by removing electric charge. In the removal of electric charge, it is not necessary to remove all the electric charge on the sheet S, and it is merely necessary to remove a part of the electric charge on the sheet S.

### Configuration of First Charge Eliminating Unit and Second Charge Eliminating Unit

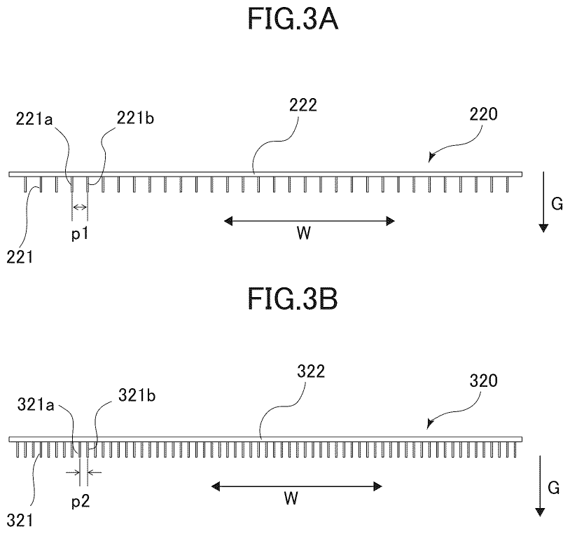

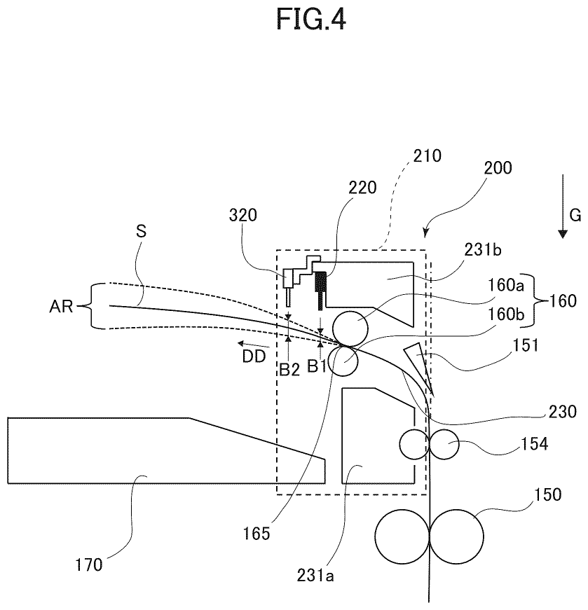

Next, the configuration of the first charge eliminating unit 220 and the second charge eliminating unit 320 will be described with reference to FIGS. 3A, 3B, and 4. FIG. 3A is a front view of the first charge eliminating unit 220, and FIG. 3B is a front view of the second charge eliminating unit 320. FIG. 4 is a cross-sectional view of the sheet discharging apparatus 200.

The first charge eliminating unit 220 includes, as illustrated in FIG. 3A, a supporting unit 222 formed of stainless steel (Steel Use Stainless; SUS), and a plurality of charge eliminating needles 221 formed of stainless steel. Stainless steel is a steel material, which is iron containing 10.5% or more chromium and 1.2% or less carbon. The plurality of charge eliminating needles 221 serving as a plurality of first charge eliminating portions and a plurality of upstream charge eliminating portions are supported on the supporting unit 222 serving as a first supporting portion and aligned in the width direction W with a first pitch p1. For example, the plurality of charge eliminating needles 221 include charge eliminating needles 221a serving as first upstream charge eliminating portions and charge eliminating needles 221b serving as second upstream charge eliminating portion that are mutually adjacent in the width direction W. A distance as a first distance between the charge eliminating needles 221a and 221b is the first pitch p1.

The second charge eliminating unit 320 includes, as illustrated in FIG. 3B, a supporting unit 322 serving as a second supporting portion, and a plurality of charge eliminating needles 321 that are supported on the supporting unit 322 and aligned in the width direction W with a second pitch p2 narrower than the first pitch p1. For example, the plurality of charge eliminating needles 321 include charge eliminating needles 321a serving as first downstream charge eliminating portions and charge eliminating needles 321b serving as second downstream charge eliminating portions that are arranged adjacent to each other in the width direction W. A distance as a second distance between the charge eliminating needles 321a and 321b is the second pitch p2, which differs from the first pitch p1.

The plurality of charge eliminating needles 321 serving as the plurality of second charge eliminating portions and the plurality of downstream charge eliminating portions are formed of amorphous metal fiber serving as an amorphous metal material. For example, amorphous metal fiber may be formed of Al-based amorphous, or of Co—Fe—Cr—Si—B based amorphous. The supporting unit 322 is formed of stainless steel or amorphous metal, for example. That is, the supporting units 222 and 322, the plurality of charge eliminating needles 221, and the plurality of charge eliminating needles 321 all have conductivity. Further, the supporting units 222 and 322 are grounded via a metal frame of the image forming apparatus 100. The charge eliminating needles 221 and 321 are formed of a plurality of wires that extend in a gravity direction G, and regardless of the material being used, they are referred to as needles or a brush in the description.

The area in which a plurality of the first charge eliminating needles 221 and a plurality of the second charge eliminating needles 321 are arranged is longer, in the width direction W, than a width of a maximum size sheet that may be used in the image forming apparatus 100. Therefore, electric charge on the entire surface of the sheet S passing through the first sheet discharge passage 230 and discharged by the first sheet discharge roller pair 160 may be eliminated by the first charge eliminating unit 220 and the second charge eliminating unit 320.

In general, when the pitch of a plurality of charge eliminating needle is widened, the charge eliminating effect by each of the charge eliminating needles of electric charge that is charged on the sheet becomes great, but there occurs an area that may not be eliminated of charge in the area between two adjacent charge eliminating needles, and the amount of charge on the sheet surface will become nonuniform.

Therefore, according to the present embodiment, a pitch p1 of the plurality of charge eliminating needles 221 of a first charge eliminating unit 220 and a pitch p2 of the plurality of charge eliminating needles 321 of a second charge eliminating unit 320 are mutually varied. More specifically, the pitch p1 of the plurality of charge eliminating needles 221 of the first charge eliminating unit 220 is set longer than the pitch p2 of the plurality of charge eliminating needles 321 of the second charge eliminating unit 320.

Thereby, the charge eliminating effect of the plurality of charge eliminating needles 221 of the first charge eliminating unit 220 arranged upstream in the sheet discharge direction DD may be improved. Therefore, even in the case of ultrathin paper and coated paper each of which tends to have a relatively large charge amount, the electric charge on the sheet may be eliminated effectively. Further, since the pitch p2 is shorter than the pitch p1, the plurality of charge eliminating needles 321 of the second charge eliminating unit 320 arranged downstream in the sheet discharge direction DD may remove charge such that the uneven electric charge remaining on the sheet S may be reduced. Therefore, it is possible to suppress the sheets being supported on a sheet discharge tray 170 from being attracted to or repelled from each other by the electric charge of the sheets S, and to improve the stackability of the sheets S.

According further to the present embodiment, the plurality of charge eliminating needles 321 of the second charge eliminating unit 320 are formed of amorphous metal fiber. The amorphous metal fiber has an extremely low electric resistance and a high conductivity. That is, the charge eliminating needles formed of amorphous metal fiber have a higher charge eliminating performance than the charge eliminating needles formed of stainless steel. Therefore, even in the case of the plurality of charge eliminating needles 321 that are aligned in the width direction W with the pitch p2 that is narrower than the pitch p1, since the needles are formed of amorphous metal fiber, a high charge eliminating performance may be retained.

As illustrated in FIG. 4, in the sheet discharge direction DD, a sheet discharge upstream roller pair 154 is arranged between the fixing unit 150 and a sheet discharge roller pair 160. The sheet S conveyed by the sheet discharge upstream roller pair 154 and guided by the first guiding member 151 toward the first sheet discharge passage 230 is guided to the first sheet discharge roller pair 160 by conveyance guides 231a and 231b forming the first sheet discharge passage 230. At areas upstream of the first sheet discharge roller pair 160 in the sheet discharge direction DD, the position of the sheet S is regulated by the sheet discharge upstream roller pair 154, the first guiding member 151, and the conveyance guides 231a and 231b, and moment locus, i.e., conveyance locus, of the sheet S will not be varied greatly.

Meanwhile, in the area downstream of the sheet discharge roller pair 160 in the sheet discharge direction DD, the sheet S nipped by the sheet discharge roller pair 160 is not retained by any of the members, and for example, the conveyance position of the sheet may vary within an area AR surrounded by a broken line of FIG. 4. Therefore, the sheet S is discharged to the first sheet discharge tray 170 serving as a sheet supporting unit while allowing variation, or deviation, of movement locus in the area AR.

As illustrated in FIG. 4, a deviation width of the sheet S in a height direction, i.e., gravity direction or vertical direction, of the sheet in the area AR is increased toward a downstream side in the sheet discharge direction DD. For example, a deviation width B2 of the sheet S in a charge eliminating position of the second charge eliminating unit 320 is greater than a deviation width B1 of the sheet S in a charge eliminating position of the first charge eliminating unit 220.

The charge eliminating effect by the charge eliminating needle may also differ according to the material of the charge eliminating needle. For example, the effective range of a charge eliminating needle made of SUS differs from that of a charge eliminating needle made of amorphous metal fiber, and the charge eliminating needle made of amorphous metal fiber has a relatively greater effective range of the charge eliminating effect. Therefore, according to the present embodiment, the first charge eliminating unit 220 including the charge eliminating needles 221 made of SUS is arranged at the upstream side position in the sheet discharge direction DD where the deviation width (B1) of the sheet S is small. Further, the second charge eliminating unit 320 including the charge eliminating needles 321 made of amorphous metal fiber is arranged at the downstream side position in the sheet discharge direction DD where the deviation width (B2) of the sheet S is great.

Therefore, even according to the second charge eliminating unit 320 disposed downstream of the first charge eliminating unit 220 in the sheet discharge direction DD, the response of charge eliminating performance with respect to the variation of position of the sheet S may be improved, and an appropriate charge eliminating effect may be expected. Therefore, the stackability of the sheet may be improved.

As described, the present embodiment is equipped with the first charge eliminating unit 220, and the second charge eliminating unit 320 arranged downstream of the first charge eliminating unit 220 in the sheet discharge direction DD. Then, by mutually varying the pitches and materials of the charge eliminating needles 221 and 321, the stackability of the sheets may be improved by eliminating charge of the sheets effectively while corresponding to various types of sheets.

According to the present embodiment, the charge eliminating needles 221 and 321 are arrange so as not to abut against the surface of the sheet S discharged by the sheet discharge roller pair 160. As described, even by arranging the charge eliminating needles 221 and 321 in the above-described manner, the electric charge is discharged from the surface of the sheet S to the charge eliminating needles 221 and 321 by corona discharge, and the charge on the sheet S may be eliminated. Further, since the sheet S will not come into contact with the charge eliminating needles 221 and 321, damaging of the sheets and the images formed on the sheets may be suppressed. It is preferable that the charge eliminating needles 221 and 321 do not come into contact with the surface of the sheet S discharged by the sheet discharge roller pair 160, but they may come into contact therewith.

### Second Embodiment

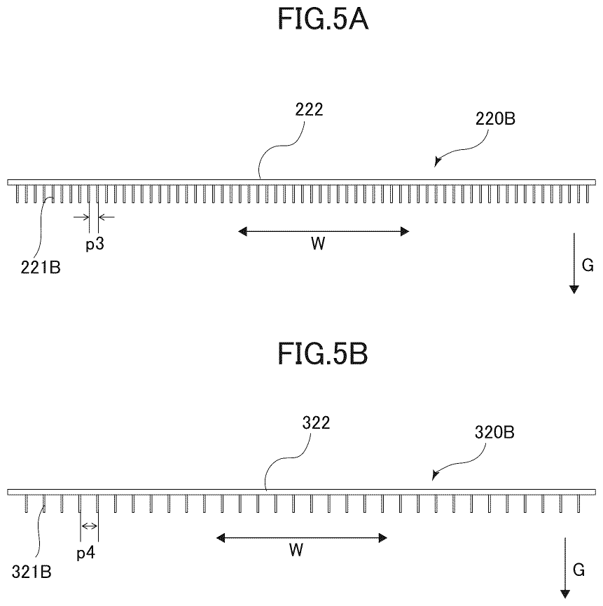

Next, a second embodiment of the present invention will be described. The second embodiment adopts a configuration in which respective pitches of charge eliminating needles on the first charge eliminating unit 220 and the second charge eliminating unit 320 according to the first embodiment are varied. Therefore, configurations similar to the first embodiment are either not shown in the drawings or denoted with the same reference numbers. FIG. 5A is a front view illustrating a first charge eliminating unit 220B according to the second embodiment, and FIG. 5B is a front view illustrating a second charge eliminating unit 320B.

As illustrated in FIG. 5A, the first charge eliminating unit 220B includes a plurality of charge eliminating needles 221B serving as a plurality of first charge eliminating portions that are supported on the supporting unit 222 and aligned in the width direction W with a third pitch p3. Further, the second charge eliminating unit 320B includes a plurality of charge eliminating needles 321B serving as a plurality of second charge eliminating portions that are supported on the supporting unit 322 and aligned in the width direction W with a fourth pitch p4. The third pitch p3 serving as a first pitch and first distance is shorter than the fourth pitch p4 serving as a second pitch and second distance. That is, according to the present embodiment, similar to the first embodiment, the respective pitches of the charge eliminating needles of the first charge eliminating unit 220B and the second charge eliminating unit 320B are varied.

Therefore, the unevenness of electric charge on the sheet S may be reduced effectively by the plurality of charge eliminating needles 221B of the first charge eliminating unit 220B. Further, the electric charge on the sheet of ultrathin paper or coated paper each of which tends to have a relatively large amount of charge may also be eliminated effectively by the plurality of charge eliminating needles 321B on the second charge eliminating unit 320B. Thereby, charge of various types of sheets may be eliminated effectively, and the stackability of sheets may be improved.

According to the present embodiment, similar to the first embodiment, the plurality of charge eliminating needles 221B of the first charge eliminating unit 220B are formed of SUS, and the plurality of charge eliminating needles 321B of the second charge eliminating unit 320B are formed of amorphous metal fiber.

### Other Embodiments

According to all of the embodiments described above, the materials of the charge eliminating needles 221 and 221B of the first charge eliminating unit 220 and 220B and the charge eliminating needles 321 and 321B of the second charge eliminating unit 320 and 320B are not limited to those described above. That is, the charge eliminating needles 221 and 221B of the first charge eliminating unit 220 and 220B are not limited to SUS, and they may be formed of amorphous metal fiber or other bristle materials having conductivity. Further, the charge eliminating needles 321 and 321B of the second charge eliminating unit 320 and 320B are not limited to amorphous metal fiber, and they may be formed of SUS or other bristle materials having conductivity. Other bristle materials having conductivity may be resin, such as nylon, acrylic resin, and polyester, or a composite material in which carbon and metal are combined arbitrarily.

Further, the supporting units 222 and 322 are also not limited to those described above. For example, the supporting units 222 and 322 may be composed of a tape having conductivity, a resin having conductivity, or a metal material.

In all of the embodiments described above, the materials of the charge eliminating needles 221 and 221B of the first charge eliminating unit 220 and 220B and the charge eliminating needles 321 and 321B of the second charge eliminating unit 320 and 320B differ from each other, but the present technique is not limited thereto. For example, the materials of the charge eliminating needles 221 and 221B of the first charge eliminating unit 220 and 220B and the charge eliminating needles 321 and 321B of the second charge eliminating unit 320 and 320B may be mutually the same.

In all of the embodiments described above, the first charge eliminating unit 220 and 220B and the second charge eliminating unit 320 and 320B are all arranged on the drive roller 160a side with respect to the sheet nipped by the nip portion 165 of the sheet discharge roller pair 160, but the present technique is not limited thereto. For example, the first charge eliminating unit 220 and 220B and the second charge eliminating unit 320 and 320B may be arranged on the driven roller 160b side with respect to the sheet nipped by the sheet discharge roller pair 160. Further, the first charge eliminating unit 220 and 220B and the second charge eliminating unit 320 and 320B may be separately arranged on the drive roller 160a side and the driven roller 160b side with respect to the sheet nipped by the sheet discharge roller pair 160. Further, the positions of the drive roller 160a and the driven roller 160b may be switched.

Further, in all of the embodiments described above, the sheet discharging apparatus 200 includes two charge eliminating units, which are the first charge eliminating unit and the second charge eliminating unit, but the present technique is not limited thereto. For example, the sheet discharging apparatus 200 may include three or more charge eliminating units distributed on the downstream side of the sheet discharge roller pair 160 in the sheet discharge direction DD. Further, the sheet discharging apparatus 200 may include one or more charge eliminating units on the upstream side of the sheet discharge roller pair 160 in the sheet discharge direction DD. Further, the sheet discharging apparatus 200 is not limited to the charge eliminating unit including the charge eliminating needles, and it may include a charge eliminating sheet composed of a conductivity sheet, or a charge eliminating tape composed of a conductivity tape. The charge eliminating sheet and the charge eliminating tape may be disposed on an opposite side as the first charge eliminating unit and the second charge eliminating unit with respect to the sheet nipped by the sheet discharge roller pair 160.

Further, in all of the embodiments described above, the extension unit 300 is disposed only on the first sheet discharge passage 230 side and not disposed on the second sheet discharge passage 240 side, but the present technique is not limited thereto. For example, it may be possible to dispose the extension unit 300 only on the second sheet discharge passage 240 side, or it may be possible to dispose the extension unit 300 on both the first sheet discharge passage 230 and the second sheet discharge passage 240.

Further, in all of the embodiments described above, the pitches of the respective charge eliminating needles of the first charge eliminating unit 220 and the second charge eliminating unit 320 have been defined, but the respective pitches are not necessary uniform for all the charge eliminating needles of the charge eliminating units. For example, the plurality of charge eliminating needles 221 of the first charge eliminating unit 220 are aligned with a first pitch p1, but for example, a manufacturing error of ±5% may be considered for the first pitch p1. The second pitch p2 may be similar to the first pitch p1.

Further, in all of the embodiments described above, the image forming apparatus 100 adopting an electrophotographic system has been described as an example, but the present technique is not limited thereto. For example, the present invention may be applied to an inkjet-type image forming apparatus for forming images on sheets by discharging ink through nozzles.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-061631, filed Apr. 5, 2024, which is hereby incorporated by reference herein in its entirety.

What is claimed is:

1. A sheet discharging apparatus including:
a sheet discharge unit configured to discharge a sheet in a sheet discharge direction;
a sheet supporting unit configured to support the sheet discharged by the sheet discharge unit;
a first charge eliminating unit arranged downstream of the sheet discharge unit in the sheet discharge direction and configured to eliminate electric charge from a surface of the sheet; and
a second charge eliminating unit arranged downstream of the first charge eliminating unit in the sheet discharge direction and configured to eliminate electric charge from a surface of the sheet,
wherein the first charge eliminating unit includes a plurality of first charge eliminating portions that are aligned with a first pitch in an intersecting direction intersecting the sheet discharge direction, and
wherein the second charge eliminating unit includes a plurality of second charge eliminating portions that are aligned with a second pitch, that differs from the first pitch, in the intersecting direction.

2. The sheet discharging apparatus according to claim 1, wherein the first pitch is longer than the second pitch.

3. The sheet discharging apparatus according to claim 1, wherein the first pitch is shorter than the second pitch.

4. The sheet discharging apparatus according to claim 1, wherein each of the plurality of first charge eliminating portions is formed of a material that differs from that of each of the plurality of second charge eliminating portions.

5. The sheet discharging apparatus according to claim 4, wherein the plurality of first charge eliminating portions are formed of stainless steel, and
wherein the plurality of second charge eliminating portions are formed of amorphous metal material.

6. The sheet discharging apparatus according to claim 1, wherein the first charge eliminating unit includes a first supporting portion having conductivity and configured to support the plurality of first charge eliminating portions, and
wherein the second charge eliminating unit includes a second supporting portion having conductivity and configured to support the plurality of second charge eliminating portions.

7. The sheet discharging apparatus according to claim 1, wherein the sheet discharge unit includes a first roller, and a second roller configured to form a nip portion, together with the first roller, that nips and conveys the sheet, and
wherein both the first charge eliminating unit and the second charge eliminating unit are arranged on a side on which the first roller is disposed with respect to the sheet nipped by the nip portion.

8. The sheet discharging apparatus according to claim 1, wherein the plurality of first charge eliminating portions and the plurality of second charge eliminating portions extend in a gravity direction.

9. An image forming apparatus comprising:
an image forming unit configured to form an image on a sheet; and
the sheet discharging apparatus according to claim 1 configured to discharge the sheet on which an image has been formed by the image forming unit.

10. A sheet discharging apparatus including:
a sheet discharge unit configured to discharge a sheet in a sheet discharge direction;
a sheet supporting unit configured to support the sheet discharged by the sheet discharge unit;
a first charge eliminating unit arranged downstream of the sheet discharge unit in the sheet discharge direction and configured to eliminate electric charge from a surface of the sheet; and
a second charge eliminating unit arranged downstream of the first charge eliminating unit in the sheet discharge direction and configured to eliminate electric charge from a surface of the sheet,
wherein the first charge eliminating unit includes a plurality of upstream charge eliminating portions aligned in an intersecting direction intersecting the sheet discharge direction, the plurality of upstream charge eliminating portions including a first upstream charge eliminating portion and a second upstream charge eliminating portion that are arranged adjacent to each other in the intersecting direction,
wherein the second charge eliminating unit includes a plurality of downstream charge eliminating portions aligned in the intersecting direction, the plurality of downstream charge eliminating portions including a first downstream charge eliminating portion and a second downstream charge eliminating portion that are arranged adjacent to each other in the intersecting direction, and
wherein a first distance between the first upstream charge eliminating portion and the second upstream charge eliminating portion differs from a second distance between the first downstream charge eliminating portion and the second downstream charge eliminating portion in the intersecting direction.

11. The sheet discharging apparatus according to claim 10, wherein the first distance is longer than the second distance.

12. The sheet discharging apparatus according to claim 10, wherein the first distance is shorter than the second distance.

13. The sheet discharging apparatus according to claim 10, wherein the first upstream charge eliminating portion and the second upstream charge eliminating portion are formed of a material that differs from that of the first downstream charge eliminating portion and the second downstream charge eliminating portion.

14. The sheet discharging apparatus according to claim 13, wherein the first upstream charge eliminating portion and the second upstream charge eliminating portion are formed of stainless steel, and
wherein the first downstream charge eliminating portion and the second downstream charge eliminating portion are formed of amorphous metal material.

15. The sheet discharging apparatus according to claim 10, wherein the first charge eliminating unit includes a first supporting portion having conductivity and configured to support the first upstream charge eliminating portion and the second upstream charge eliminating portion, and
wherein the second charge eliminating unit includes a second supporting portion having conductivity and configured to support the first downstream charge eliminating portion and the second downstream charge eliminating portion.

16. The sheet discharging apparatus according to claim 10, wherein the sheet discharge unit includes a first roller, and a second roller configured to form a nip portion, together with the first roller, that nips and conveys the sheet, and
wherein both the first charge eliminating unit and the second charge eliminating unit are arranged on a side on which the first roller is disposed with respect to the sheet nipped by the nip portion.

17. The sheet discharging apparatus according to claim 10, wherein each of the first upstream charge eliminating portion, the second upstream charge eliminating portion, the first downstream charge eliminating portion, and the second downstream charge eliminating portion extends in a gravity direction.

18. An image forming apparatus comprising:
an image forming unit configured to form an image on a sheet; and
the sheet discharging apparatus according to claim 10 configured to discharge the sheet on which an image has been formed by the image forming unit.
